(19) United States
(12) Patent Application Publication
(10) Pub. No.: US 2017/0338578 A1
(43) Pub. Date: Nov. 23, 2017

(54) PLUG CONNECTOR HAVING A TERMINAL PROTECTOR

(71) Applicant: FOXCONN INTERCONNECT TECHNOLOGY LIMITED, Grand Cayman (KY)

(72) Inventors: CHENG ZHANG, Kunshan (CN); XIAO FAN, Kunshan (CN); JUN CHEN, Kunshan (CN); JERRY WU, Irvine, CA (US)

(21) Appl. No.: 15/597,502

(22) Filed: May 17, 2017

(30) Foreign Application Priority Data
May 17, 2016 (CN) 201610324772.X

(51) Int. Cl. H01R 13/24; H01R 13/62; H01R 13/516

(52) U.S. Cl. CPC H01R 13/2421; H01R 13/516; H01R 13/6205

(57) ABSTRACT

A plug connector (100) includes: a sleeve (1) having a receiving cavity (11); and a terminal module (10) including a fixed body (7) received in the receiving cavity (11), an insulative housing (11) located in front of the fixed body (7) and extended beyond the sleeve (1), a magnetic element (6) received in the sleeve (1), a plurality of movable terminals (4), and plural elastic elements (5), the insulative housing (11) having a number of through holes (31), the other end of the elastic element (5) bearing against the fixed body (7), the movable terminals (4) in non-retracted state being located inwardly of the insulative housing (3), the insulative housing (3) being operable to move backwards urging against the elastic elements (5) and exposing the movable terminals (4) in retracted state out of the insulative housing (3); wherein the movable terminals (4) are sheathed in the elastic elements (5).

### BACKGROUND OF THE INVENTION

### 1. Field of the Invention

The present disclosure relates to a plug connector having a movable terminal protector and associated elastic elements.

### 2. Description of Related Arts

U.S. Patent Application Publication No. 2015/0333432, published on Nov. 19, 2015, discloses a plug connector comprising a magnetic element having a cavity; a contact protector movably accommodated in the cavity, the protector defining a front end and a plurality of slots through the front end; a plurality of retractable, e.g., POGO-type, contacts accommodated in the slots, each contact having a front end located in the front end of the contact protector; and an elastic element urging the contact protector to extend the front end thereof out of the cavity. The elastic element is arranged on both sides of the plurality of contacts such that the dimension of the accommodating cavity is increased.

An improved plug connector is desired.

### SUMMARY OF THE INVENTION

Accordingly, an object of the present invention is to provide a plug connector of a reduced size.

To achieve the above object, a plug connector comprises: a sleeve having a receiving cavity; and a terminal module including a fixed body received in the receiving cavity, an insulative housing located in front of the fixed body and extended beyond the sleeve, a magnetic element received in the sleeve, a plurality of movable terminals, and a plurality of elastic elements, the insulative housing having a plurality of through holes, one end of the movable terminal being received in a corresponding through hole, the other end of the movable terminal being fixed on the fixed body, one end of the elastic element bearing against the insulative housing, the other end of the elastic element bearing against the fixed body, the movable terminals in non-retracted state being located inwardly of the insulative housing, the insulative housing being operable to move backwards urging against the elastic elements and exposing the movable terminals in retracted state out of the insulative housing; wherein the movable terminals are sheathed in the elastic elements.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a plug connector adapted to be mated with a receptacle connector;

FIG. 2 is a perspective view of the plug connector is ready to be mated with a receptacle connector;

FIG. 3 is an exploded view of plug connector as show in FIG. 2;

FIG. 4 is a further exploded view of plug connector as shown in FIG. 3;

FIG. 5 is another exploded view of plug connector as shown in FIG. 4;

FIG. 6 is across section view of plug connector taken along line 6-6 in FIG. 1; and

FIG. 7 is across section view of plug connector taken along line 7-7 in FIG. 2.

### DETAILED DESCRIPTION OF THE PREFERRED EMBODIMENT

Reference will now be made in detail to the preferred embodiment of the present invention.

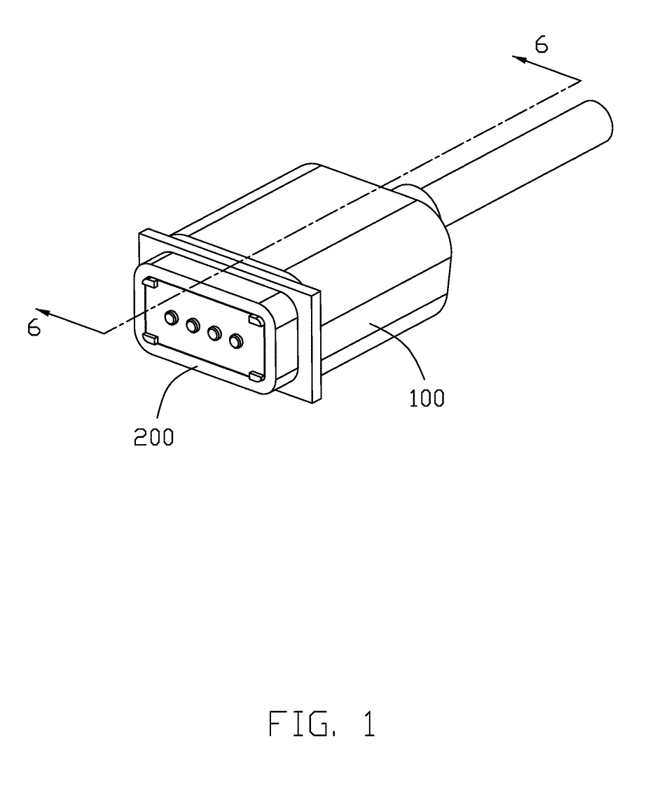

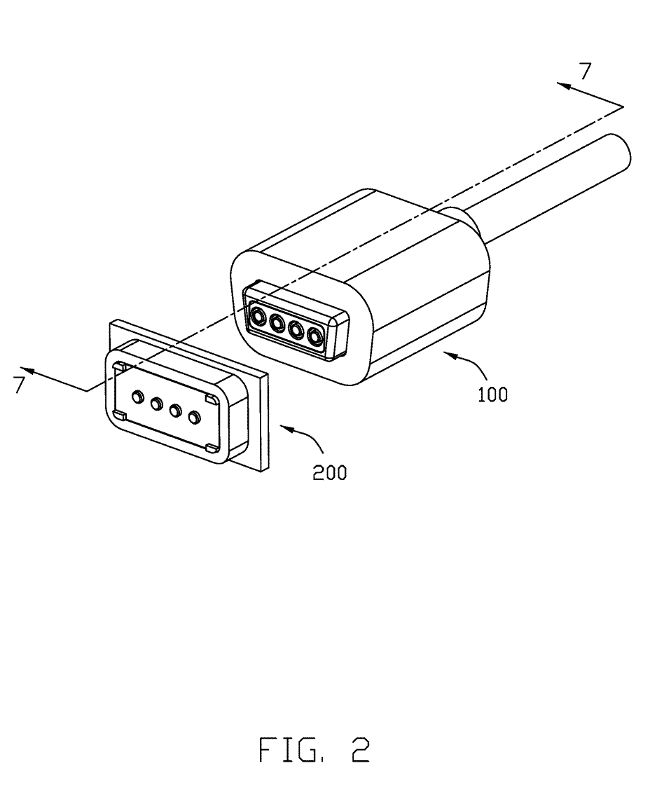

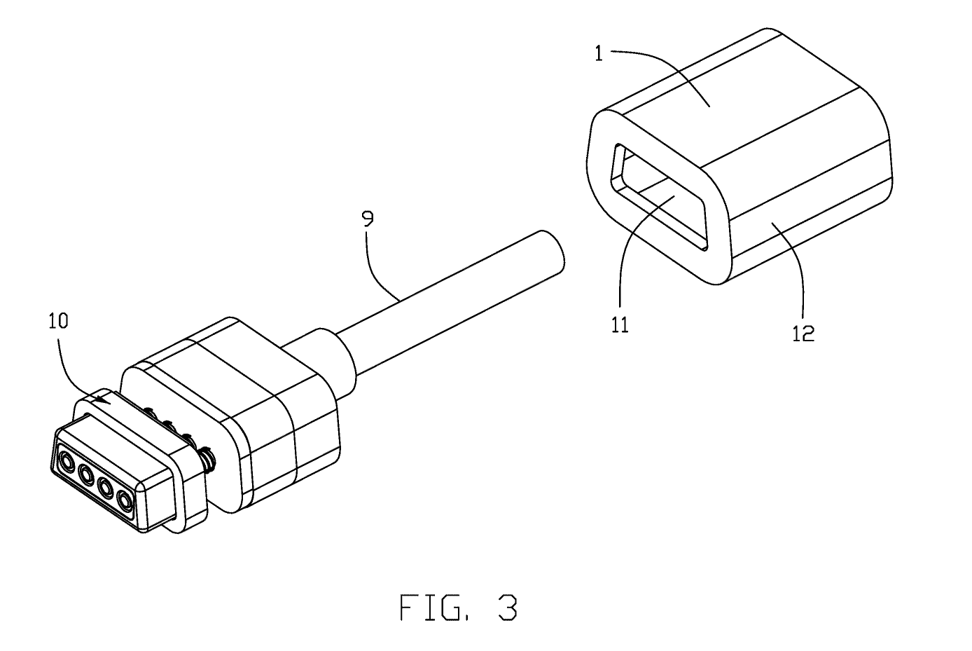

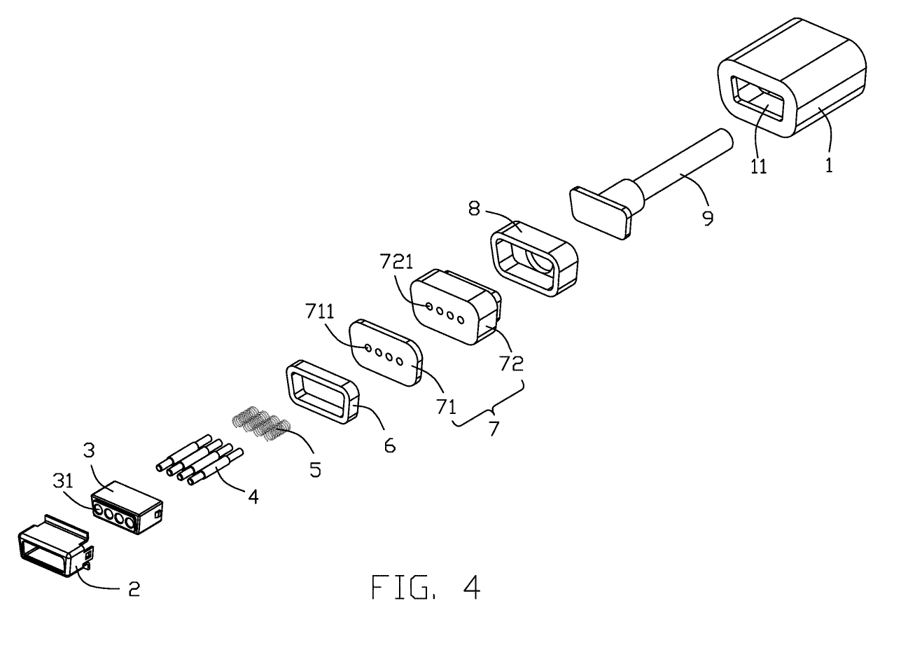

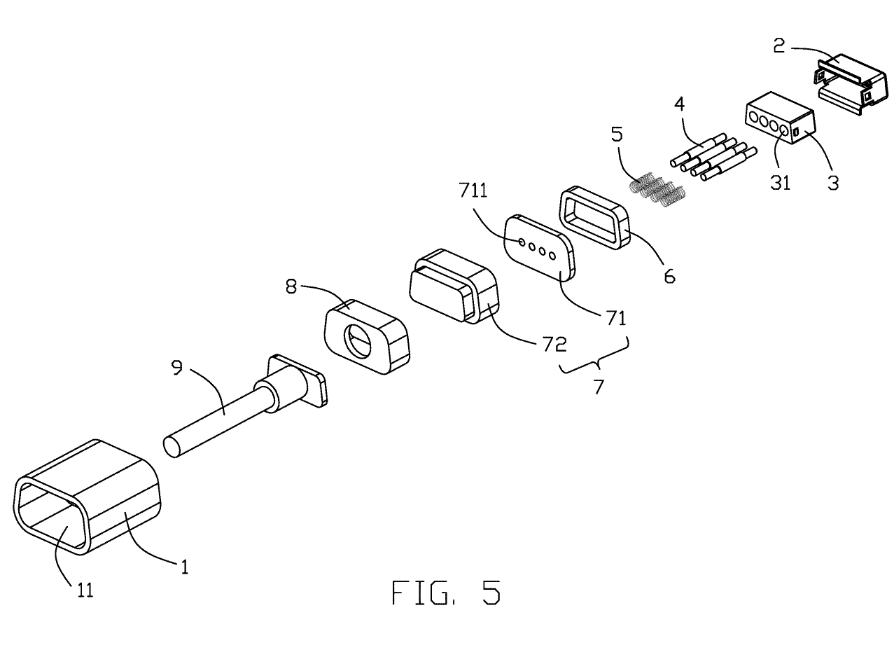

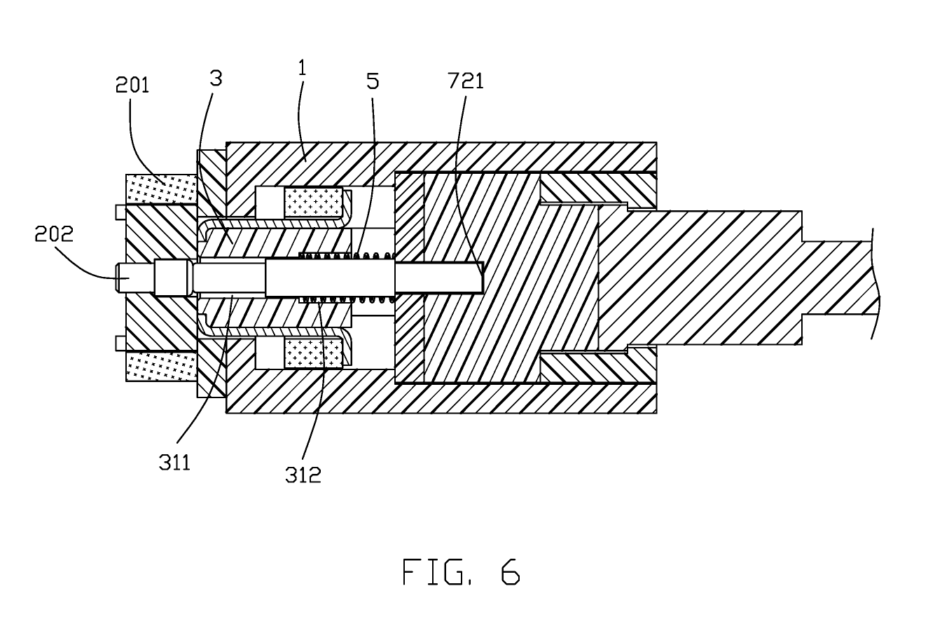

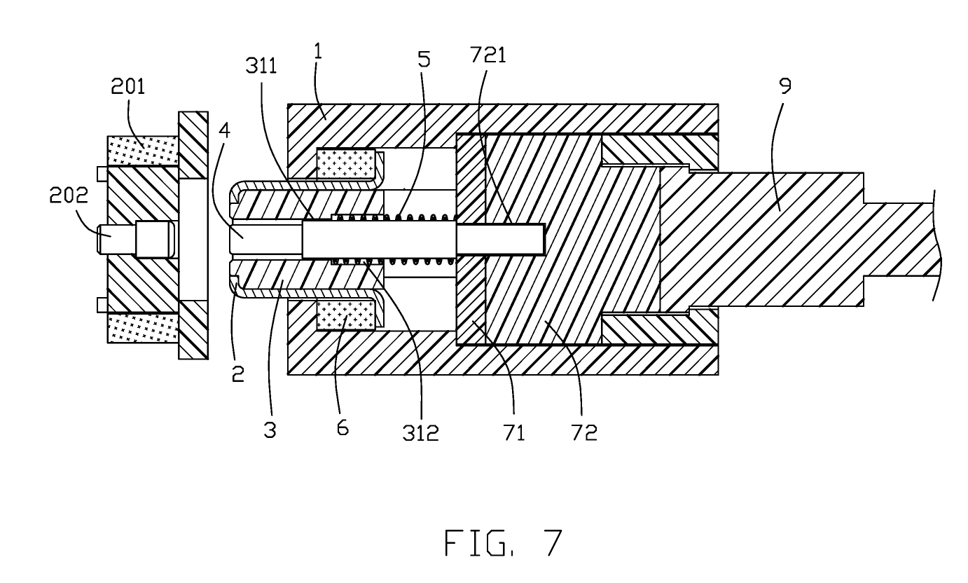

Referring to FIGS. 1 to 7, a plug connector 100 adapted to be matched with receptacle connector 200 by magnetic attraction. The plug connector 100 includes a cylinder sleeve 1, a terminal module 10, and a cable 9 behind the terminal module 2.

The cylinder sleeve 1 comprises a receiving cavity 11 through the cylinder sleeve 1 in front to back direction and a plurality of side walls 12 around the receiving cavity 11.

The terminal module 10 including a fixed body 7 received in the receiving cavity 11, an insulative housing 3 located in front of the fixed body 7 and extended beyond the cylinder sleeve 1, a magnetic element 6 received in the cylinder sleeve 1 and around the insulative housing 3, a metal shell 2 enclosed in the insulative housing 3, a plurality of elastic elements 5, and a plurality of movable terminals 4 arranged along the transverse direction. The fixed body 7 is used for fixing the rear end of the movable terminals 4 and includes a fixing member 71 and a module 72 assembled at rear end of the fixing member 71. The fixing member 71 includes a plurality of pinholes 711, the movable terminals 4 extending through the corresponding pinholes 711. The module 72 includes a plurality of grooves 721, and the movable terminals 4 are inserted into the grooves 721. The insulative housing 3 includes a plurality of through holes 31 extending along the front to back direction. The movable terminals 4 may penetrate the through hole 31. The through hole 31 includes a first through hole 311 and a second through hole 312 behind the first through hole 311, the diameter of the second through hole 312 being larger than the diameter of the first through hole 311. One end of the elastic elements 5 is received in the second through hole 312 and bears against the inner wall of the second through hole 312 and the first through hole 311. The magnetic element 6 is made of a magnetic material and can be attracted by corresponding socket magnetic element 201 on the receptacle connector 200 to provide the connecting force between the plug connector 100 and the receptacle connector 200. The magnetic element 6 is approximately “D” shape and sheathed on the rear end of the metal shell 2. In this embodiment, the magnetic element 6 is a magnet. One end of the movable terminals 4 is received in the corresponding through hole 31, the other end is fixed on the corresponding grooves 721 of the module 72. In this embodiment, the movable terminals 4 are pogo pins and include springs.

The elastic element 5 is sheathed on the movable terminals 4 so as to save the space of the receiving cavity 11, thereby reducing the size of the plug connector 100. One end of the elastic element 5 bears against the insulative housing 3 and the other end bears against the fixed body 7. In this embodiment, elastic elements 5 are springs. The diameter of the cross section of the elastic element 5 is larger than the diameter of the pinhole 711 of the fixing member 71.

When the plug connector 100 is in a non working condition (not mated with the receptacle connector), the movable terminals 4 are located in the through hole 31 of the insulative housing 3. When the plug connector 100 is in a working condition (mated with the receptacle connector), magnetic element 6 and socket magnetic element 201 are attracted to each other. The insulative housing 3 is moved backwards by the force of the external force to drive the elastic elements 5 to be compressed backward, and the movable terminals 4 are exposed to the outside of the insulative housing 3. The plug connector 100 and the receptacle connector 200 are mated together and the movable terminals 4 are contacted with the socket terminal 202 to complete the electrical connection.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A plug connector comprising:
a sleeve having a receiving cavity; and
a terminal module including a fixed body received in the receiving cavity, an insulative housing located in front of the fixed body and extended beyond the sleeve, a magnetic element received in the sleeve, a plurality of movable terminals, and a plurality of elastic elements, the insulative housing having a plurality of through holes, one end of the movable terminal being received in a corresponding through hole, the other end of the movable terminal being fixed on the fixed body, one end of the elastic element bearing against the insulative housing, the other end of the elastic element bearing against the fixed body, the movable terminals in non-retracted state being located inwardly of the insulative housing, the insulative housing being operable to move backwards urging against the elastic elements and exposing the movable terminals in retracted state out of the insulative housing; wherein
the movable terminals are sheathed in the elastic elements.

2. The plug connector as claimed in claim 1, wherein the elastic elements are springs.

3. The plug connector as claimed in claim 1, wherein the through hole includes a first through hole and a second through hole behind the first through hole, the diameter of the second through hole is larger than the diameter of the first through hole, and one end of the elastic element is received in the second through hole.

4. The plug connector as claimed in claim 1, wherein the fixed body includes a fixing member and a module assembled at a rear end of the fixing member.

5. The plug connector as claimed in claim 4, wherein the fixing member includes a plurality of pinholes, the movable terminals extending through corresponding pinholes.

6. The plug connector as claimed in claim 5, wherein the diameter of the pinhole is smaller than the diameter of the elastic element.

7. The plug connector as claimed in claim 4, wherein the module includes a plurality of grooves, and the movable terminals are inserted into corresponding grooves, respectively.

8. The plug connector as claimed in claim 1, wherein the terminal module includes a metal shell enclosing the insulative housing, and the magnetic element is mounted on a rear end of the metal shell.

9. The plug connector as claimed in claim 8, wherein the magnetic element is approximately D-shaped and sheathed on the rear end of the metal shell, and the magnetic element comprises a magnet.
